(19) United States
(12) Patent Application Publication
(10) Pub. No.: US 2006/0256086 A1
(43) Pub. Date: Nov. 16, 2006

(54) Integrated optical mouse

(76) Inventors: Tong Xie, San Jose, CA (US); Marshall Thomas DePue, San Jose, CA (US)

Correspondence Address: AVAGO TECHNOLOGIES, LTD., P.O. BOX 1920, DENVER, CO, 80201-1920, US

(21) Appl. No.: 11/129,196

(22) Filed: May 12, 2005

(51) Int. Cl. G09G 5/08

(52) U.S. Cl. 345/166

(57) ABSTRACT

An optical mouse includes a package cover and a substrate mounted in the package cover. An illumination source is attached to the substrate for illuminating a navigation surface with radiation. A sensor is attached to the substrate for detecting radiation reflected off the navigation surface. A first level interconnect electrically connects a circuit formed on the substrate with the illumination source and sensor. Integration allows for a compact form-factor and low-cost manufacturing.

### BACKGROUND OF THE INVENTION

The use of hand operated pointing devices to control the position of a cursor on a computer display has become extremely widespread. The most popular of such navigation devices is the mouse. Recently, in computer mice being commercialized in the United States, the mechanical ball that partially protrudes through the underside of the mouse has been replaced with an optical tracking device to avoid failures due to lint build-up and mechanical wear associated with the ball. Optical mice track relative motion between the pointing device and the navigation surface which is usually a desktop or mouse pad. This results in improved performance compared to mechanical mice. See U.S. Pat. No. 6,281,882 granted Aug. 28, 2001 to Gordon et al., assigned to Agilent Technologies, Inc., and entitled PROXIMITY DETECTOR FOR A SEEING EYE MOUSE.

In an optical mouse a light source is used to provide illumination and a sensor array is used to capture images of the navigation surface. Conventionally the light source and the sensor array are separately packaged devices mounted on a printed circuit board assembly within an ergonomically shaped outer plastic housing. For example, a T1 or SMT packaged LED is typically used inside an optical mouse employing an LED as the light source. In an optical mouse that employs lasers as the light source, a edge emitting laser or a vertical cavity surface emitting laser (VCSEL) die is packaged inside a TO can. The light sensor array in both types of optical mice is typically mounted in a lead frame or SMT package. Thus conventional optical mice include a navigation module with a relatively large physical size and manufacturing cost. Stack-up tolerances resulting from the assembly of individual parts also increase manufacturing cost, and reduces the overall system-level tolerance budget.

### SUMMARY OF THE INVENTION

In accordance with an embodiment of the invention, an optical mouse includes a substrate, an illumination source attached to the substrate capable of illuminating a navigation surface, and a sensor attached to the substrate capable of detecting radiation reflected off the navigation surface. A first level interconnect electrically connects a circuit formed on the substrate with the illumination source and the sensor.

### BRIEF DESCRIPTION OF THE DRAWINGS

FIG. 1 is a diagrammatic vertical cross-sectional view of a first embodiment of an integrated optical mouse in accordance with the invention.

FIG. 2A is a diagrammatic vertical cross-sectional view of a second embodiment of an integrated optical mouse in accordance with the invention.

FIG. 2B illustrates a modified version of the second embodiment.

FIG. 3 is a diagrammatic vertical cross-sectional view of a third embodiment of an integrated optical mouse in accordance with the invention.

FIG. 4 is a diagrammatic vertical cross-sectional view of a fourth embodiment of an integrated optical mouse in accordance with the invention.

FIG. 5 is a diagrammatic vertical cross-sectional view of a fifth embodiment of an integrated optical mouse in accordance with the invention.

Throughout the drawing figures like reference numerals refer to like parts.

### DETAILED DESCRIPTION

Optical mice in accordance with various embodiments of the invention typically utilize image correlation techniques to determine relative motion between the device and the navigation surface by capturing successive images of the surface. The captured images may be speckle patterns, diffraction patterns, photographs of the surface topography, patterns of intensity variations due to shadows cast on the surface, etc. Both the displacement and the direction of relative motion of the optical mice with respect to the navigation surface may be determined by comparing one image with the following image. Other techniques beside image correlation, for example the spatial filtering of speckle patterns, are well-known in the art. Optical mice in accordance with the present invention may use coherent, incoherent, or quasi-coherent illumination, depending upon the desired intensity contrast in the captured images. High-contrast, feature-rich images simplify computational overhead and reduce power consumption. Optical mice in accordance with the invention enable more accurate positioning of the cursor than mechanical mice.

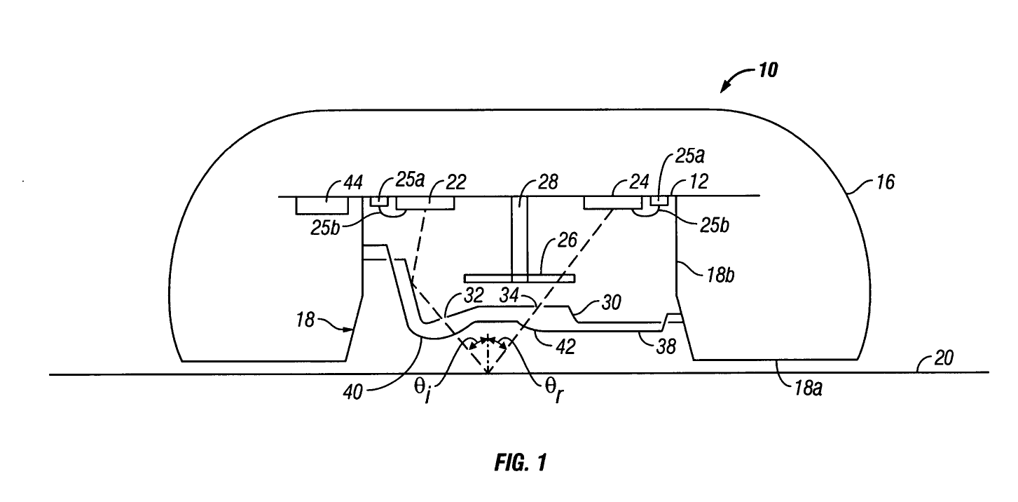

Referring to FIG. 1, a first embodiment of an optical mouse 10 in accordance with the invention includes substrate 12, such as a printed circuit board (PCB), inside outer housing 16. Since optical mouse 10 will be grasped in the hand of a user for long periods of time outer housing 12 is ergonomically configured to achieve maximum comfort and ease of use. Flared base 18 is connected to outer housing 16 which fits over flared base 18. Flared base 18 provides an underside to optical mouse 10. Horizontal portions 18a of flared base 18 slide over navigation surface 20 such as a desk top or mouse pad. Vertical portions 18b of flared base 18 connect to, and position, substrate 12 a predetermined distance above navigation surface 20. Illumination source 22 is die-attached to substrate 12 for illuminating navigation surface 20 with radiation. Sensor 24 is die-attached to substrate 12 for detecting radiation reflected off navigation surface 20. Illumination source 22 is preferably an unpackaged light emitting diode (LED) die, edge emitting laser diode die, or vertical cavity surface emitting laser (VCSEL) die. Sensor 24 is preferably an unpackaged array of charge coupled devices (CCDs) or a complementary metal oxide semiconductor active pixel sensor (CMOS-APS). Sensor 24 could also be a GaAs, amorphous silicon or other suitable detector array. Dies 22 and 24 are connected to electrically conductive circuitry 25a on the substrate 12 via wire bonds 25b. Circuitry 25a can be etched copper conductors, contact pads, thin film traces, etc. Other forms of first level interconnect besides wire bonding 25b can be used to electrically connect dies 22 and 24 to circuitry 25a, including flip chip bonding and tape automated bonding (TAB).

Opaque beam block 26 (FIG. 1) is mounted to substrate 12 via support 28 between illumination source 22 and sensor 24. Beam block 26 substantially prevents stray radiation, i.e. unwanted scattered light, from directly impinging on sensor 24. Transparent plastic cover piece 30 snaps into the base 18. Beam block 26 may also be formed as an integral portion of cover piece 30. Cover piece 30 is formed with a first optical aperture 32 through which radiation from illumination source 22 is directed to navigation surface 20 and a second optical aperture 34 through which radiation reflected off navigation surface 20 is directed to sensor 24. The radiation from the illumination source 22 is reflected via total internal reflection (TIR) within cover piece 30 to navigation surface 20.

Optics module 38 (FIG. 1), which is also made of transparent plastic, mates with and snaps over cover piece 30. Collimating lens 40 and imaging lens 42 are integrally formed in optics module 38 so that they are aligned with apertures 32 and 34, respectively, for directing radiation from illuminating source 22 onto navigation surface 20 and for directing reflected radiation onto sensor 24. The optical path is illustrated by dashed lines in FIG. 1. In one embodiment, illumination source 22 and sensor 24 are positioned so that the angle of incidence θᵢ of the radiation striking navigation surface 20 and the angle of reflection θᵣ off navigation surface 20 are substantially equal. This ensures that the resulting signal from the sensor 24 represents the specular reflection. It is desirable to locate illumination source 22 close to sensor 24. This minimizes the angle of incidence θᵢ and the angle of reflection θᵣ and allows a small form-factor optical mouse to be manufactured for travel usage with portable laptop personal computers. Preferably θᵢ and θᵣ are greater than zero degrees and less than about twenty degrees. Sensor 24 may be angled so that the radiation it receives is substantially normal to its plane.

Collimating lens 40 may be eliminated, or imaging lens 42 may be eliminated, or both may be eliminated, depending upon the physical principal used in optical mouse 10 to determine displacement and the geometry of the desired form factor of optical mouse 10. The captured images may be speckle patterns, diffraction patterns, photographs of the surface topology, patterns of intensity variation due to shadows cast on the surface, etc. However, those skilled in the art will appreciate that typically, the optics module 38 will include at least one lens.

Different physical principles, including speckle, diffraction, shadow imaging, or direct imaging of the surface height profile, may be employed in optical mouse 10, depending upon the degree to which optical mouse 10 is supposed to perform on different types of navigation surface 20. A laser or LED may be positioned at an oblique angle and scattered light imaged normal to the plane of navigation surface 20 in order to maximize sensitivity to shadow patterns on the surface. Illumination source 22 and sensor 24 may be mounted in various configurations (near specular is preferred) in order to image speckle patterns.

In the case of diffraction, light rays reflect and scatter in many different directions when navigation surface 20 is microscopically rough. When either a coherent or quasi-coherent illumination source is utilized, high contrast intensity patterns produced by interference among reflected and scatter light beams may be observed in the resulting diffraction pattern. The interference effects provide enhanced contrast to the images for navigation purposes. The images of navigation surface 20 produced by a coherent illumination source, such as a VCSEL, typically include surface features and interference features. The presence of speckle in the images is not used for navigation purposes.

Optics module 38 (FIG. 1) is mounted on the exterior of cover piece 30, but may also be mated with, and mounted on, the interior of cover piece 30. If illumination source 22 emits quasi-coherent radiation, such as a narrow band LED or an LED with a narrow bandwidth filter, then a lens or limiting aperture is beneficial for navigation on a smooth surface. Use of a limiting aperture (for example aperture 34 in cover piece 30) reduces the power incident on navigation surface 20 but improves spatial coherence. Collimating lens 40 may be a diffractive lens or a refractive lens, or other suitable optical element and may be optically coated to improve performance. Instead of using a limiting aperture together with a conventional narrow band LED, a narrow band edge emitting LED may be used for illumination source 22. Imaging lens 42 may be a diffractive lens or a refractive lens or other suitable optical element for imaging portions of navigation surface 20 and may be optically coated with dielectric thin film to improve performance.

An image data signal from sensor 24 is sent to a navigation engine in packaged cursor motion controller 44 die-attached to substrate 12. Motion controller 44 generates delta X and delta Y navigation output signals that are used to control movement of a cursor on a display as is well known to those skilled in the art of designing computer mice. The maximum navigation speed over navigation surface 20 depends on the maximum frame rate of sensor 24 as well as the processing time for the motion calculation. Correlation of successive images is typically used to determine displacement and direction. In this case, successive captured images partially overlap with one another. Hence motion controller 44 identifies features in each image and calculates the displacement and direction of the relative motion. Those skilled in the art will recognize the tradeoffs between the cost of sensor 24, cursor motion controller 44, total power consumption and the desired performance of optical mouse 10 over various navigation surfaces from a rough mouse pad to a smooth glass desktop.

Optical mouse 10 is preferably connected to a personal computer (PC), personal digital assistant (PDA) or other computing device via radio frequency (RF) or infrared (IR) wireless connection via transmitter electronics (not illustrated). Additional electronic functions can be provided in other devices that may also be die-attached to substrate 12. These may include a universal serial bus (USB) driver or wireless controller (not illustrated) for a cordless mouse. Optical mouse 10 is preferably powered by an alkaline or other disposable battery, a rechargeable battery, a fuel cell, a solar cell, or other small portable power source (not illustrated).

Illumination source 22 and sensor 24 may be placed on separate substrates and electronically connected. However, both dies are still enclosed by cover piece 30. Illumination source 22 or sensor 24 may be packaged as separate discrete components. Alternatively, illumination source 22 and sensor 24 may be contained in a single package.

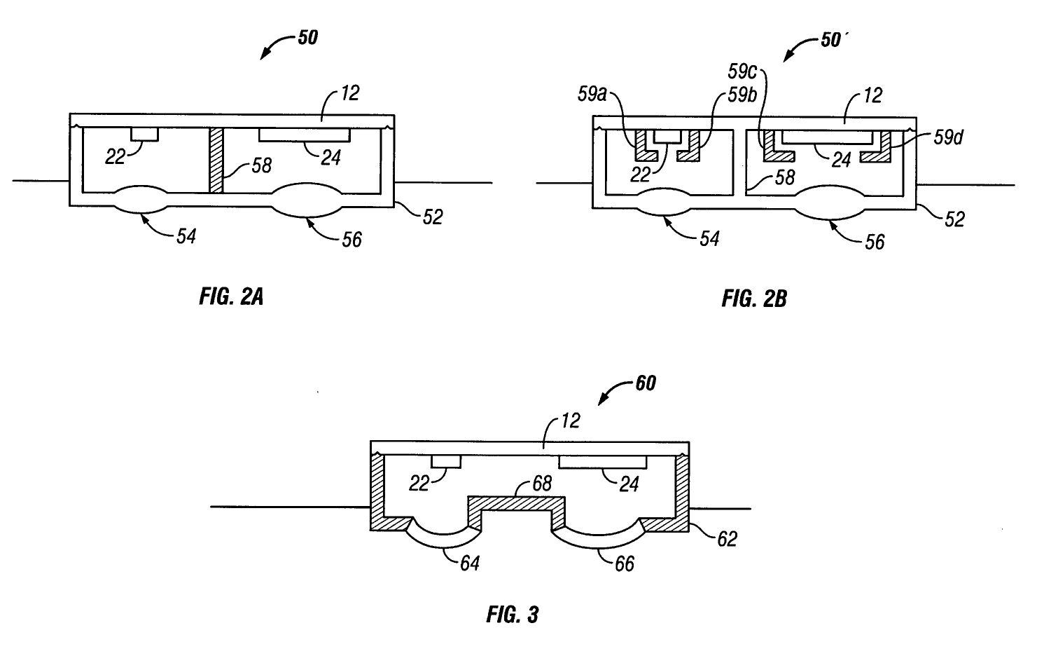

Referring to FIG. 2A, a second embodiment 50 in accordance with the invention includes a single transparent cover piece 52 that serves as the enclosure for the electronics inside the integrated package. Cover piece 52 snaps into substrate 12. Collimating lens 54 and imaging lens 56 are attached (for example snap-fit) to cover piece 52. Alternatively, lenses 54 and 56 may be integrally formed in the transparent cover piece 52. A wall portion 58 of the transparent cover piece 52 where light needs to be blocked to prevent stray light, may be coated with dark plastic film coating or any suitable type of light absorbing or non-light transmitting material, to form a beam block. The opaque nature of the wall portion 58 is illustrated by cross-hatched areas in FIG. 2A. Alternatively, a separate opaque plastic beam block could be used and, for example, snap-fit into cover piece 52. FIG. 2B illustrates a modification of the second embodiment 50′ in which shoulders 59a, 59b, 59c and 59d attached to substrate 12 provide apertures for restricting the radiation emitted by illumination source 22 and received by sensor 24. They also function as beam blocks. Depending on the physical principal used in optical mouse 10, one or more of shoulders 59a, 59b, 59c and 59d may be omitted.

Referring to FIG. 3, a third embodiment 60 in accordance with the invention includes a single cover piece 62 made with both opaque material and optical material using a double-shot molding process. The opaque portions are cross-hatched in FIG. 3. This eliminates the need for any separately formed beam block. Beam block 68 is provided by a raised portion of cover piece 62 between lenses 64 and 66. Transparent plastic lenses 64 and 66 are thus integral parts of the cover piece 62, the remainder of which is made of opaque plastic material. Cover piece 62 snaps into substrate 12.

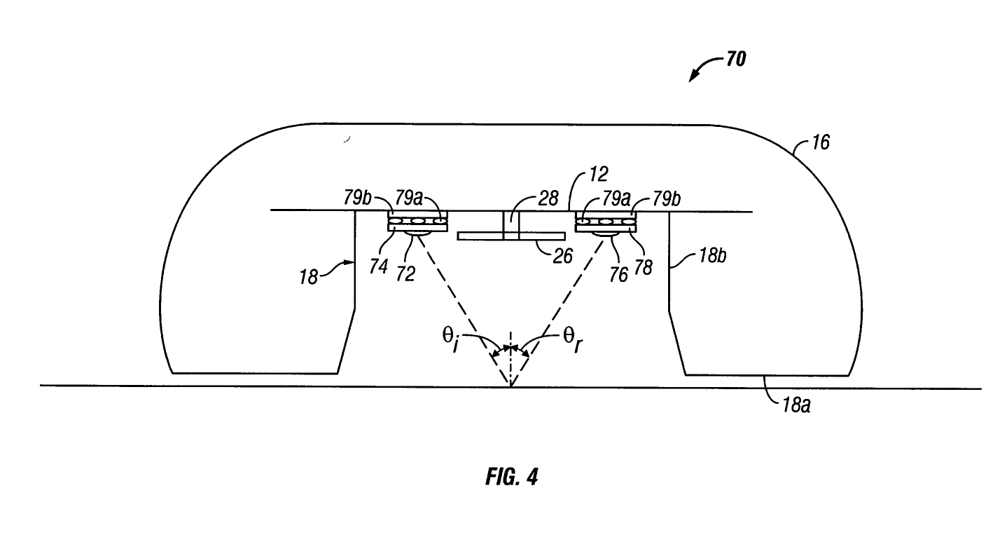

Referring to FIG. 4, in a fourth embodiment 70 in accordance with the invention the optics used for imaging and illumination may be integrated at the chip level. Collimating lens 72 is integrated and attached directly to illumination source die 74 through an encapsulated package scheme. Similarly, imaging lens 76 is integrated and attached directly to sensor die 78 through a wafer level process. Flip chip bonding, including solder balls 79a, is used to electrically connect dies 74 and 78 to circuitry 79b formed on substrate 12.

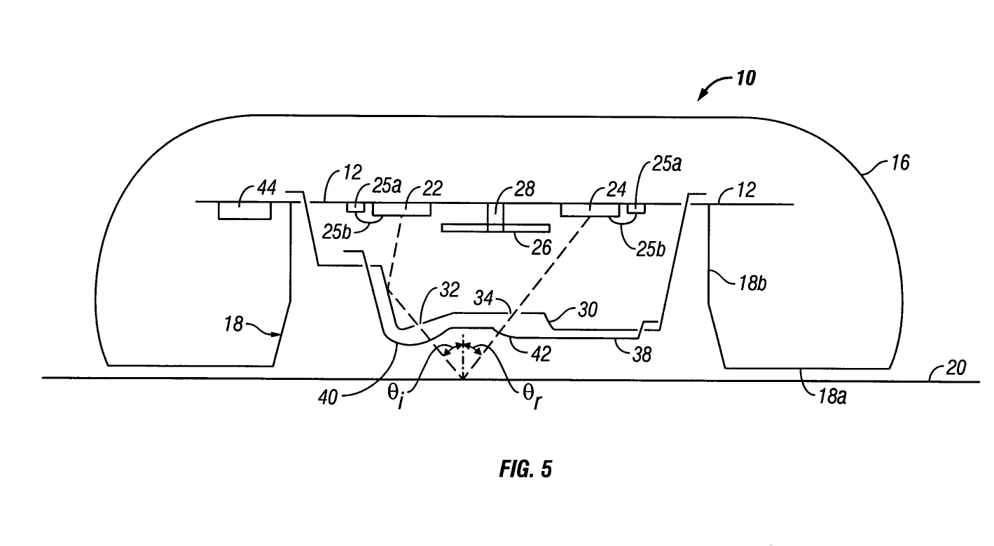

Referring to FIG. 5, in a fifth embodiment 80 in accordance with the invention optics module 38 snaps over cover piece 30 which in turn snaps over substrate 12.

While various embodiments of optical mice in accordance with the invention have been described, it will be appreciated by those skilled in the art that the invention can be varied and modified in both arrangement and detail. For example, raw or intermediate data from the sensor may be sent to a central processing unit (CPU) for processing physically separate from the optical mouse, thereby eliminating one or more discrete circuit elements otherwise supported on substrate 12. Therefore, the protection afforded our invention should only be limited in accordance with the following claims.

1. An optical mouse, comprising:
a substrate;
an illumination source attached to the substrate capable of illuminating a navigation surface; and
a sensor attached to the substrate capable of detecting radiation reflected off the navigation surface;
a circuit formed on the substrate; and
a first level interconnect between the illumination source and sensor and the circuit.

2. The optical mouse of claim 1 wherein the illumination source is selected from the group consisting of an LED die, an edge emitting laser diode die, and a VCSEL die.

3. The optical mouse of claim 1 wherein the sensor is selected from the group consisting of a CCD array and a CMOS image sensor.

4. The optical mouse of claim 1 and further comprising an ergonomically shaped housing enclosing the substrate.

5. The optical mouse of claim 1 and further comprising an opaque beam block that substantially prevents stray radiation from the illumination source from directly impinging on the sensor.

6. The optical mouse of claim 1 and further comprising a cover piece connected to the substrate and having a first aperture for allowing the passage of radiation from the illumination source and a second aperture for allowing the passage of radiation reflected off the navigation surface.

7. The optical mouse of claim 1 and further comprising an optics module that mates with the substrate and includes at least one lens.

8. The optical mouse of claim 5 and further comprising an optics module that mates with the cover piece and has first and second lenses integrally formed therein that align with the first and second apertures, respectively.

9. The optical mouse of claim 1 and further comprising a base that positions the substrate a predetermined distance above the navigation surface.

10. The optical mouse of claim 1 and wherein the substrate is a printed circuit board.

11. An optical mouse, comprising:
an illumination source capable of illuminating a navigation surface;
a sensor capable of detecting radiation reflected off the navigation surface;
a substrate that supports the illumination source and the sensor; and
a cover piece connected to the substrate and having a first aperture for allowing the passage of radiation from the illumination source and a second aperture for allowing the passage of radiation reflected off the navigation surface.

12. The optical mouse of claim 11 wherein the illumination source is selected from the group consisting of an LED die, an edge emitting laser diode die, and a VCSEL die.

13. The optical mouse of claim 11 wherein the sensor is selected from the group consisting of a CCD array and a CMOS image sensor.

14. The optical mouse of claim 11 and further comprising an opaque beam block that substantially prevents stray radiation from the illumination source from directly impinging on the sensor.

15. The optical mouse of claim 11 wherein the illumination source and the sensor are positioned so that an angle of incidence of radiation from the illumination source relative to the navigation surface substantially equals an angle of reflection of radiation to the sensor relative to the navigation surface.

16. The optical mouse of claim 11 and further comprising an optics module that mates with the cover piece and has at least one lens.

17. The optical mouse of claim 11 and further comprising a base that positions the substrate a predetermined distance above the navigation surface.

18. The optical mouse of claim 17 and further comprising a housing that fits over the base.

19. The optical mouse of claim 11 wherein the substrate is a printed circuit board.

20. An optical mouse, comprising:
an illumination source capable of illuminating a navigation surface;
a sensor capable of detecting radiation reflected off the navigation surface;
a substrate that supports the illumination source and the sensor;
a cover piece connected to the substrate and having a first aperture for allowing the passage of radiation from the illumination source and a second aperture for allowing the passage of radiation reflected off the navigation surface; and
an optics module that mates with the cover piece and has first and second lenses integrally formed therein that align with the first and second apertures, respectively.
